(19) United States
(12) Patent Application Publication
(10) Pub. No.: US 2011/0252207 A1
(43) Pub. Date: Oct. 13, 2011

(54) DYNAMIC CONTENT ARCHIVING

(75) Inventors: John Louis JANOSIK, JR., Nashua, NH (US); David Lane Diamond, Mont Vernon, NH (US); Michael Rubino, Nashua, NH (US); Michael Sekurski, Winchendon, MA (US); Michael Gianatassio, Hooksett, NH (US)

(73) Assignee: ORACLE INTERNATIONAL CORPORATION, Redwood Shores, CA (US)

(21) Appl. No.: 12/756,512

(22) Filed: Apr. 8, 2010

(51) Int. Cl. G06F 12/16

(52) U.S. Cl. 711/161; 711/E12.103

(57) ABSTRACT

Systems, methods, and other embodiments associated with dynamic content archiving are disclosed. A system archive trigger parameter that is related to a present operational status of one or more system components is monitored. The system archive trigger parameter is evaluated with respect to a trigger condition. If the system archive trigger parameter meets the trigger condition, content is automatically selected for archiving based, at least in part, on a content archive criteria. The selected content is compressed and stored. In some embodiments, compressed content is automatically decompressed and provided to a user in response to the user's request for the content.

### BACKGROUND

Content management systems are tasked with managing extremely large quantities of data. Every day more media (image, movie, sound, and text files) may be stored by users of the content management system, eventually causing the content management system to fill its memory space. Content management systems are usually required to keep all data, even old or seldom used data, until it is deleted by a user, resulting in memory space overruns. To deal with memory space overruns, system administrators typically add additional memory media or archive selected content off-system. System administrators may also choose to compress certain content to free up memory space. These solutions can be costly (in terms of new hardware) or time consuming for the system administrator. Also, depending on the compression and storage techniques used, the compressed or archived content may not be readily available to users of the content management system.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an example embodiment of a method associated with dynamic content archiving.

FIG. 2 illustrates another example embodiment of a method associated with dynamic content archiving.

FIG. 3 illustrates an example embodiment of a system associated with dynamic content archiving.

FIG. 4 illustrates another example embodiment of a system associated with dynamic content archiving.

FIG. 5 illustrates an example computing environment in which example systems and methods, and equivalents, may operate.

### DETAILED DESCRIPTION

The methods and systems described herein dynamically archive older and/or seldom used content to free up memory capacity. In a content management system context, dynamic content archiving includes automatically, without user intervention or request, determining that the system could benefit from an increase in memory capacity, selecting content for archiving, and archiving the selected content in a manner that liberates at least some of the memory capacity that was taken up by the selected content. In one example embodiment, the archiving process includes compressing the content.

Dynamic content archiving may also include automatically, without user intervention, retrieving an archived content that has been requested by the user and processing the content so that it can be presented to the user. For example, if the requested content has been compressed as part of the archiving process, the content can be automatically de-compressed prior to providing it to the user. Thus, in some example embodiments, the user should not know that the content she is requesting has been archived. Dynamic content archiving automatically and transparently conserves memory capacity while keeping content available to users, providing a software solution to a hardware problem.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Logic”, as used herein, includes but is not limited to hardware, firmware, software stored as computer executable instructions on a computer-readable medium or in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

“User”, as used herein, includes but is not limited to one or more persons, software, computers or other devices, or combinations of these.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

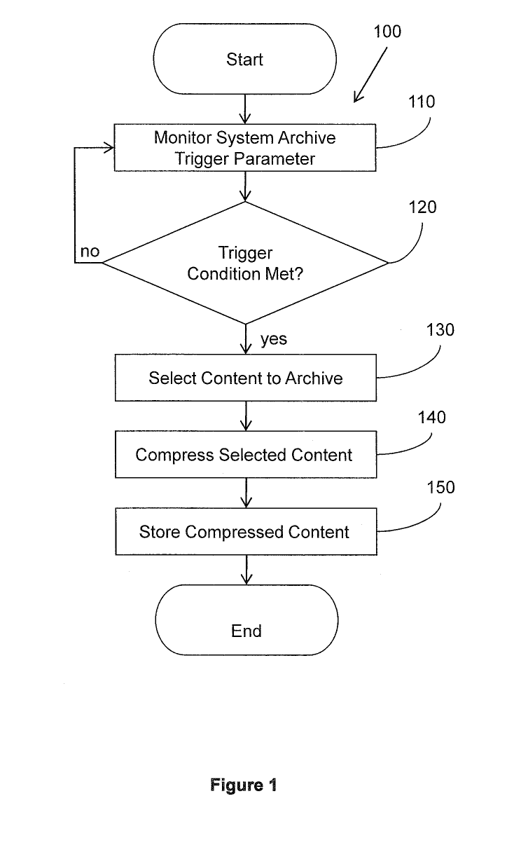

FIG. 1 illustrates an example embodiment of a method 100 associated with dynamic content archiving. At 110, a system archive trigger parameter is monitored. The system archive trigger parameter is related to a present operational status of one or more system components. By way of example, the system archive trigger may be an amount of remaining disk space available to a content management system. Thus, the system archive trigger is based on the present operational status of system components rather than a user input such that the dynamic content archiving method 100 proceeds without requiring user intervention. In some example embodiments, a system administrator or user may select one or more system archive trigger parameters.

At 120, the system archive trigger parameter is evaluated with respect to a trigger condition. For example, if the system archive trigger parameter is an amount of remaining disk space, the trigger condition may be a minimum amount of available memory necessary for acceptable system performance. If the system archive trigger parameter meets the trigger condition at 130 content is automatically selected for archiving. The content to be archived is selected based, at least in part, on a content archive criteria. Content archive criteria can be selected to target content that is not likely to be accessed in the near future. One example content archive criteria is a period of time that has elapsed since the last access of the content. A last access or modification date for content files is typically tracked by content management systems and may thus be accessed to select content for archiving. This content archive criteria is based on the assumption that the longer it has been since given content has been accessed, the less likely it is that the content will be accessed again. Another content archive criteria may be a time between the last two accesses of given content. In some example embodiments, a system administrator or user may specify the content archive criteria to be used to select content for archiving.

At 140 the selected content is compressed and at 150 the compressed content is stored. The compressed content occupies less memory space than it did when it was not compressed, freeing up memory capacity. The triggering of the archive process, the selection of content to archive, as well as the compression and storage of the selected content occurs automatically, without user intervention.

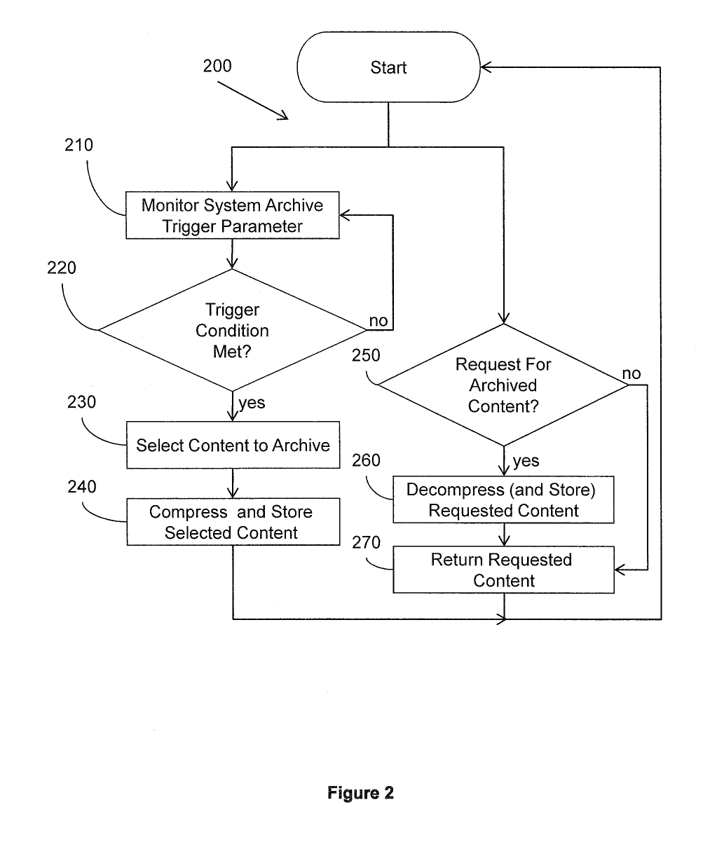

FIG. 2 illustrates another example embodiment of a method 200 associated with dynamic content archiving. The method 200 performs similar steps to those outlined with respect to FIG. 1 with an additional set of steps related to automatic decompression of files upon a user request for content. At 210, a system archive trigger parameter is monitored. The system archive trigger parameter is related to a present operational status of one or more system components. At 220, the system archive trigger parameter is evaluated with respect to a trigger condition. If the system archive trigger parameter meets the trigger condition at 230 content is automatically selected for archiving based, at least in part, on a content archive criteria. At 240 the selected content is compressed and stored.

The method 200 also includes steps related to automatic decompression of compressed content that has been requested by a user. At 250, user requests are monitored to determine if access to archived content has been requested. At 260, if a request for compressed content is received, the compressed content is automatically decompressed. The decompressed content may be stored for access by other users, in which case the trigger criteria are reset. At 270 the decompressed content is returned in response to the request. In this manner, the user need not be aware that the content he has requested has been compressed. The decompression of archived content is transparent to the user.

While FIGS. 1 and 2 illustrate various actions occurring in serial, it is to be appreciated that various actions illustrated in FIGS. 1 and 2 could occur substantially in parallel. By way of illustration, a first process could monitor a system archive trigger parameter, a second process could select content for archiving, and a third process could archive the selected content. While three processes are described, it is to be appreciated that a greater and/or lesser number of processes could be employed and that lightweight processes, regular processes, threads, and other approaches could be employed.

In one example, methods described herein may be implemented as computer executable instructions. Thus, in one example, a computer-readable medium may store computer executable instructions that if executed by a machine (e.g., processor) cause the machine to perform a method that includes automatically selecting content to archive based, at least in part, on a content archive criteria when a system archive trigger parameter is determined to meet a trigger condition; and compressing and storing the selected content. The instructions may also include automatically decompressing compressed content upon a request for the compressed content and returning the decompressed content in response to the request.

While executable instructions associated with the above method are described as being stored on a computer-readable medium, it is to be appreciated that executable instructions associated with other example methods described herein may also be stored on a computer-readable medium.

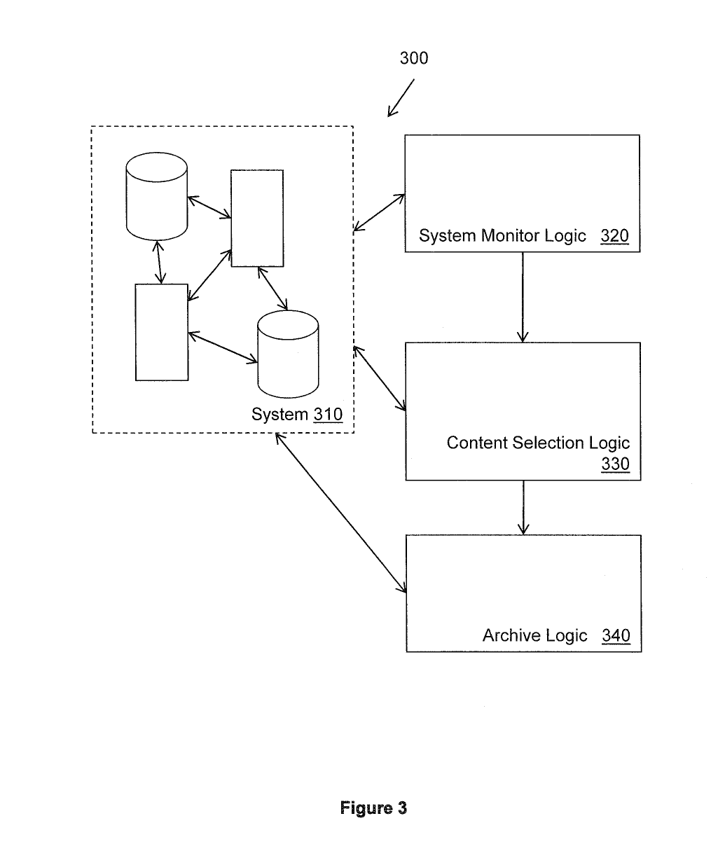

FIG. 3 illustrates an example embodiment of a computing system 300 associated with dynamic content archiving. The system includes a system monitor logic 320 to monitor a system archive trigger parameter that includes a present operational status of one or more system components (collectively system 310) that process or store data. The system monitor logic 320 also evaluates the monitored system archive trigger parameter with respect to a trigger condition. In one example embodiment, the system components include computer components that make up a content management system, i.e., storage devices such as disks, processing units, data routing and transfer components, and so on. The computing system 300 also includes a content selection logic 330 to select content to archive based, at least in part, on a content archive criteria. The content selection logic 330 is actuated by the system monitor logic 320 when the trigger condition is met. The computing system includes an archive logic 340 to compress the content selected by the content selection logic 330 and to store the compressed content. While the system 300 has been described in the context of a content management system, the system 300 may be advantageously employed with any file management system or operating system that could benefit from dynamic content archiving.

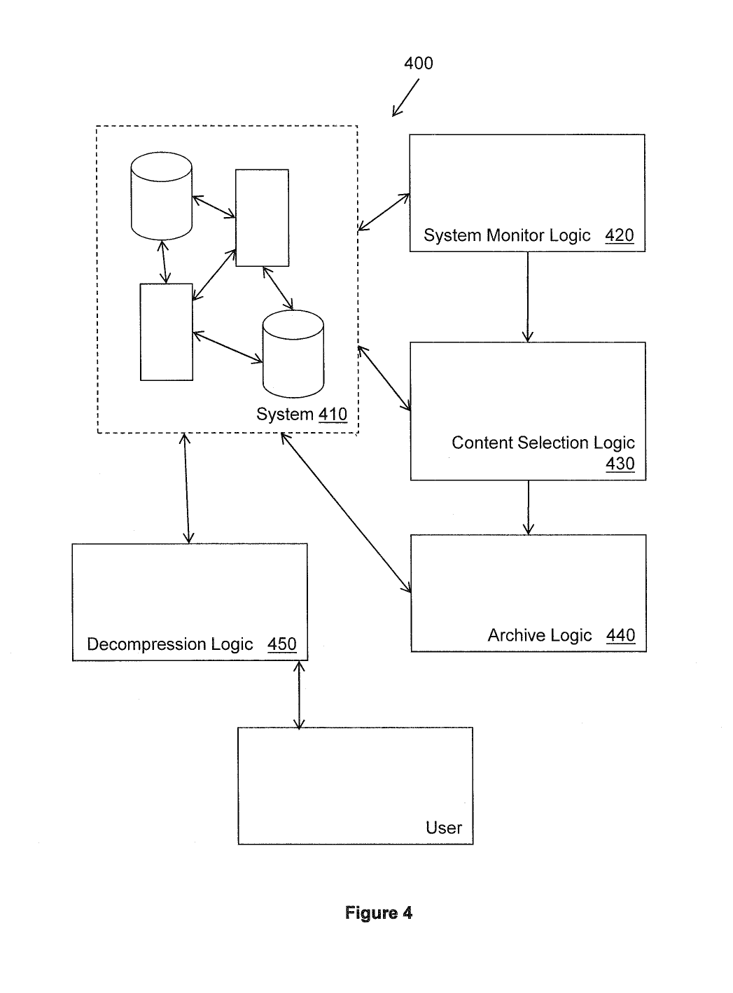

FIG. 4 illustrates another example embodiment of a computing system 400 associated with dynamic content archiving. The computing system 400 includes similar logical units to those outlined with respect to FIG. 3 with an additional set of logical units related to automatic decompression of files upon user request. The system 400 includes a system monitor logic 420 to monitor a system archive trigger parameter that includes a present operational status of one or more system components (collectively system 410) that process or store data. The computing system 400 also includes a content selection logic 430 to select content to archive based, at least in part, on a content archive criteria and an archive logic 440 to compress the selected content and to store the compressed content. In addition the system 400 includes a decompression logic 450 to automatically decompress a compressed content upon a user request for the compressed content and to return the decompressed content in response to the request.

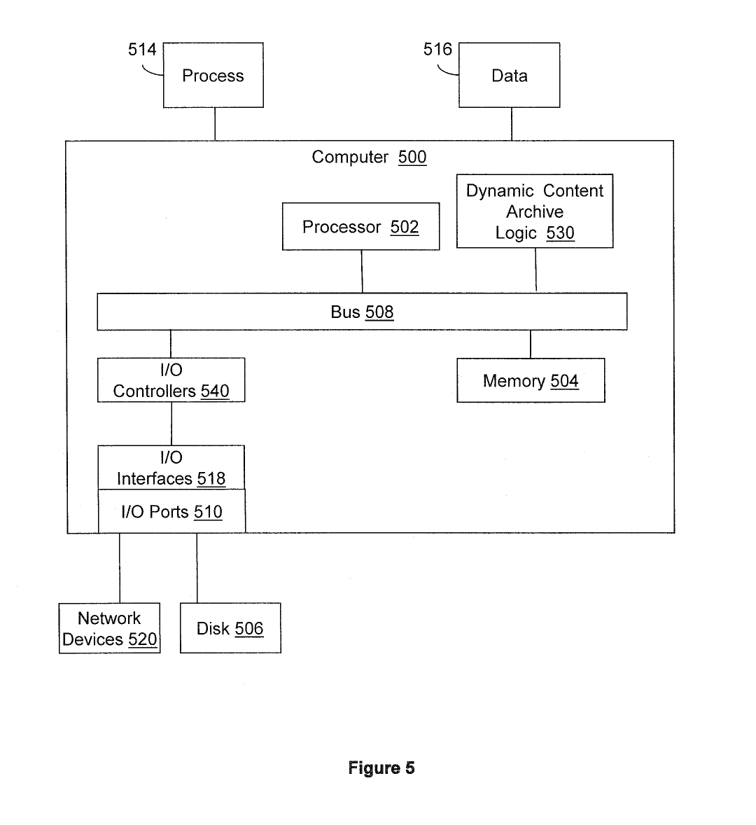

FIG. 5 illustrates an example computing device in which example systems and methods described herein, and equivalents, may operate. The example computing device may be a computer 500 that includes a processor 502, a memory 504, and input/output ports 510 operably connected by a bus 508. In one example, the computer 500 may include a dynamic content archive logic 530 configured to facilitate dynamic content archiving. In different examples, the logic 530 may be implemented in hardware, software, firmware, and/or combinations thereof. While the logic 530 is illustrated as a hardware component attached to the bus 508, it is to be appreciated that in one example, the logic 530 could be implemented in the processor 502.

Thus, logic 530 may provide means (e.g., hardware, software, firmware) for monitoring a system archive trigger parameter comprising a present operational status of one or more system components; for automatically selecting content to archive based, at least in part, on a content archive criteria when the system archive trigger parameter meets a trigger condition; for compressing the selected content; and for storing the compressed content.

Logic 530 may also provide means (e.g., hardware, software, firmware) for automatically decompressing compressed content upon a request for the compressed content; and for returning the decompressed content in response to the request.

Generally describing an example configuration of the computer 500, the processor 502 may be a variety of various processors including dual microprocessor and other multi-processor architectures. A memory 504 may include volatile memory and/or non-volatile memory. Non-volatile memory may include, for example, ROM, PROM, and so on. Volatile memory may include, for example, RAM, SRAM, DRAM, and so on.

A disk 506 may be operably connected to the computer 500 via, for example, an input/output interface (e.g., card, device) 518 and an input/output port 510. The disk 506 may be, for example, a magnetic disk drive, a solid state disk drive, a floppy disk drive, a tape drive, a Zip drive, a flash memory card, a memory stick, and so on. Furthermore, the disk 506 may be a CD-ROM drive, a CD-R drive, a CD-RW drive, a DVD ROM, and so on. The memory 504 can store a process 514 and/or a data 516, for example. The disk 506 and/or the memory 504 can store an operating system that controls and allocates resources of the computer 500.

The bus 508 may be a single internal bus interconnect architecture and/or other bus or mesh architectures. While a single bus is illustrated, it is to be appreciated that the computer 500 may communicate with various devices, logics, and peripherals using other busses (e.g., PCIE, 1394, USB, Ethernet). The bus 508 can be types including, for example, a memory bus, a memory controller, a peripheral bus, an external bus, a crossbar switch, and/or a local bus.

The computer 500 may interact with input/output devices via the i/o interfaces 518 and the input/output ports 510. Input/output devices may be, for example, a keyboard, a microphone, a pointing and selection device, cameras, video cards, displays, the disk 506, the network devices 520, and so on. The input/output ports 510 may include, for example, serial ports, parallel ports, and USB ports.

The computer 500 can operate in a network environment and thus may be connected to the network devices 520 via the i/o interfaces 518, and/or the i/o ports 510. Through the network devices 520, the computer 500 may interact with a network. Through the network, the computer 500 may be logically connected to remote computers. Networks with which the computer 500 may interact include, but are not limited to, a LAN, a WAN, and other networks.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A computer-readable medium storing computer executable instructions that when executed by a computer cause the computer to perform a method, the method comprising:
monitoring a system archive trigger parameter comprising a present operational status of one or more system components;
when the system archive trigger parameter is determined to meet a trigger condition, automatically selecting content to archive based, at least in part, on a content archive criteria;
compressing the selected content; and
storing the compressed content.

2. The computer-readable medium of claim 1 where the method comprises:
automatically decompressing compressed content upon a request for the compressed content; and
returning the decompressed content in response to the request.

3. The computer-readable medium of claim 2 comprising storing the decompressed content and resetting the archive trigger parameter.

4. The computer-readable medium of claim 1 where the system archive trigger parameter comprises memory usage on a system storage component.

5. The computer-readable medium of claim 1 where the content archive criteria comprises a time since last access of given content.

6. The computer-readable medium of claim 1 where the content archive criteria comprises a time between a last two accesses of given content.

7. A computing system, comprising:
a system monitor logic to monitor a system archive trigger parameter comprising a present operational status of one or more system components that process or store data, the system monitor logic also evaluating the system archive trigger parameter with respect to a trigger condition;
a content selection logic to, upon a determination that the trigger condition has been met, select content to archive based, at least in part, on a content archive criteria; and
an archive logic to compress the selected content and to store the compressed content.

8. The computing system of claim 7 comprising:
a decompression logic to automatically decompress compressed content upon a request for the compressed content and to return the decompressed content in response to the request.

9. The computing system of claim 8 where the decompression logic stores the decompressed content and resets the archive trigger parameter.

10. The computing system of claim 7 where the system archive parameter comprises memory usage.

11. The computing system of claim 7 where the content archive criteria comprises a time since last access of given content.

12. The computing system of claim 7 where the content archive criteria comprises a time between a last two accesses of given content.

13. A computer-implemented method comprising:
automatically selecting content to archive based, at least in part, on a content archive criteria when a system archive trigger parameter comprising a present operational status of one or more system components is determined to meet a trigger condition; and
automatically compressing and storing the selected content.

14. The computer-implemented method of claim 13 comprising:
monitoring a content management system to determine when the system archive trigger parameter meets the trigger condition.

15. The computer-implemented method of claim 13 comprising:
automatically decompressing compressed content upon a request for the compressed content;
storing the decompressed content;
resetting the system archive trigger parameter; and
returning the decompressed content in response to the request.

16. The computer-implemented method of claim 13 where the system archive parameter comprises memory usage.

17. The computer-implemented method of claim 13 where content archive criteria comprises a time since last access of given content.

18. The computer-implemented method of claim 13 where the content archive criteria comprises a time between a last two accesses of given content.

19. A system, comprising:
means for monitoring a system archive trigger parameter comprising a present operational status of one or more content management system components;
means for automatically selecting content to archive based, at least in part, on a content archive criteria when the system archive trigger parameter is determined to meet a trigger condition;
means for compressing the selected content; and
means for storing the compressed content.

20. The system of claim 19 comprising:
means for automatically decompressing compressed content upon a request for the compressed content; and
means for returning the decompressed content in response to the request.
